(19) United States
(12) Patent Application Publication
(10) Pub. No.: US 2025/0202110 A1
(43) Pub. Date: Jun. 19, 2025

(54) SYSTEMS, APPARATUSES, AND METHODS USING TWO-LEVEL BEAM STEERING

(71) Applicant: HUAWEI TECHNOLOGIES CO., LTD., Shenzhen (CN)

(72) Inventors: Ahmed Abdellatif, Shenzhen (CN); David Neal Wessel, Shenzhen (CN); Wenyao Zhai, 19073352 (CN); Hari Krishna Pothula, Shenzhen (CN); Mehri Borhani, Shenzhen (CN)

(21) Appl. No.: 19/073,352

(22) Filed: Mar. 7, 2025

Related U.S. Application Data
(63) Continuation of application No. PCT/CN2022/118190, filed on Sep. 9, 2022.

(51) Int. Cl. H01Q 3/36; H01Q 3/24; H01Q 13/00

(52) U.S. Cl. CPC H01Q 3/36; H01Q 3/24; H01Q 13/00

(57) ABSTRACT

An antenna array has a plurality of antenna elements, one or more first beam-steering components, and one or more second beam-steering components. The plurality of antenna elements are partitioned into one or more antenna groups, each antenna group comprising one or more antenna elements. Each of the one or more first beam-steering components is connected to one of the one or more antenna elements for steering a signal beam along a first plane, and each of the one or more second beam-steering components is connected to one of the one or more antenna groups for steering the signal beam along a second plane.

### CROSS-REFERENCE TO RELATED APPLICATION

The present application is a continuation of Patent Cooperation Treaty Application Serial No. PCT/CN2022/118190, entitled “SYSTEMS, APPARATUSES, AND METHODS USING TWO-LEVEL BEAM STEERING,” filed on Sep. 9, 2022, the entirety of which is incorporated by reference herein.

### FIELD OF THE DISCLOSURE

The present disclosure relates generally to wireless systems, apparatuses, and methods using beam steering, and in particular to wireless systems, apparatuses, and methods using two-level beam steering for forming signal beams.

### BACKGROUND

Beamforming has been widely used in various applications such as wireless communications and radar. As those skilled in the art understand, beamforming refers to transmitting a wireless signal towards a specific direction or device by forming a signal beam towards the specific direction or device rather than transmitting the wireless signal along all directions.

Generally, beamforming uses multiple antennas to form a signal beam. Among various beam forming techniques, beam steering is a beamforming technique that changes the phase of input signals on each transmitting antenna to steer or change the direction of the signal beam. For example, many millimeter-wave (mmWave) wireless applications require beam steering.

### SUMMARY

According to one aspect of this disclosure, there is provided a method comprising: controlling one or more antenna elements in each of one or more antenna groups for steering a signal beam along a first plane; and controlling the one or more antenna groups for steering the signal beam along a second plane.

In some embodiments, the first plane is an elevation plane and the second plane is an azimuth plane.

In some embodiments, the first plane is perpendicular to the second plane.

In some embodiments, the first plane is one of an elevation plane and an azimuth plane, and the second plane is the other one of the elevation plane and the azimuth plane.

In some embodiments, said controlling the one or more antenna elements in each of the one or more antenna groups for steering the signal beam along the first plane comprises: controlling the one or more antenna elements in each of the one or more antenna groups using one or more first phase shifters, one or more first beam switches, or one or more first waveguides for steering the signal beam along the first plane; and/or said controlling the one or more antenna groups for steering the signal beam along the second plane comprises: controlling the one or more antenna groups using one or more second phase shifters, one or more second beam switches, or one or more second waveguides for steering the signal beam along the second plane.

According to one aspect of this disclosure, there is provided an antenna array comprising: a plurality of antenna elements partitioned into one or more antenna groups, each antenna group comprising one or more antenna elements; a plurality of first beam-steering components each connected to one of the plurality of antenna elements for steering a signal beam along a first plane; and one or more second beam-steering components each connected to one of the one or more antenna groups for steering the signal beam along a second plane.

In some embodiments, the first plane is an elevation plane and the second plane is an azimuth plane.

In some embodiments, the first plane is perpendicular to the second plane.

In some embodiments, the first plane is one of an elevation plane and an azimuth plane, and the second plane is the other one of the elevation plane and the azimuth plane.

In some embodiments, the one or more first beam-steering components comprise one or more first phase shifters, one or more first beam switches, or one or more first waveguides; and/or the one or more second beam-steering components comprise one or more second phase shifters, one or more second beam switches, or one or more second waveguides.

In some embodiments, the antenna array further comprises: one or more first circuit structures comprising the plurality of antenna elements and the one or more first beam-steering components; and at least one second circuit structure coupled to the one or more first circuit structures and comprising the one or more second beam-steering components.

In some embodiments, the at least one second circuit structure comprises at least one second circuit board.

In some embodiments, the at least one second circuit board comprises a plurality of components attached thereto using wire-bonds, flip-chipped, and/or wire-bond ball-grid arrays (BGA) packages.

In some embodiments, the at least one second circuit board is coupled to a third circuit board using BGA packages.

In some embodiments, the at least one second circuit board comprises a plurality of transmitters and/or receivers.

In some embodiments, the at least one second circuit board comprises a heatsink; and wherein the heatsink and the plurality of transmitters and/or receivers are on opposite sides of the at least one second circuit board.

In some embodiments, the one or more first circuit structures comprise a plurality of first circuit structures spaced apart from each other and are parallel to each other.

In some embodiments, each adjacent pair of the plurality of first circuit structures have a distance of λ/2 therebetween, where λ is the wavelength of the signal beam.

In some embodiments, the plurality of first circuit structures are spaced apart by one or more spacers.

In some embodiments, the plurality of first circuit structures are coupled to one side of the at least one second circuit structure in an orientation perpendicular to the at least one second circuit structure.

In some embodiments, the plurality of first circuit structures are coupled to the one side of the at least one second circuit structure via RF connectors, substrate-integrated waveguides (SIWs), and/or soldering.

In some embodiments, the plurality of first circuit structures have a rectangular shape of a same size, a semi-circular shape of a same size, or a semi-circular shape of different sizes.

In some embodiments, the plurality of first circuit structures are coupled to an end of the at least one second circuit structure.

In some embodiments, the one or more first circuit structures are coupled to the end of the at least one second circuit structure in an orientation perpendicular to the at least one second circuit structure.

In some embodiments, the one or more first circuit structures are coupled to the end of the at least one second circuit structure via a plurality of end-launch connector assemblies.

In some embodiments, each of the plurality of end-launch connector assemblies comprises a first end-launch connector coupled to one of the one or more first circuit structures, a second end-launch connector coupled to one of the at least one second circuit structure, and a transition block for securing the first and second end-launch connectors together.

In some embodiments, the antenna array further comprises an extension board mounted thereon the transition blocks of the plurality of end-launch connector assemblies.

In some embodiments, the at least one second circuit structure comprises two second circuit boards parallel to each other.

In some embodiments, the two second circuit boards are configured for steering signal beams of different polarizations.

In some embodiments, the plurality of antenna elements comprise a plurality sets of antenna elements for steering signal beams of different frequencies.

In some embodiments, the plurality sets of antenna elements are interleaved on the one or more first circuit structures.

In some embodiments, the one or more first circuit structures comprise one or more first circuit boards.

In some embodiments, the one or more first circuit structures comprises one or more waveguides.

In some embodiments, the one or more first circuit structures comprises one or more waveguides coupled to a plurality of stacked circuit boards.

### BRIEF DESCRIPTION OF THE DRAWINGS

FIG. 1 is a simplified schematic diagram showing a communication system, according to some embodiments of this disclosure;

FIG. 2 is a simplified schematic diagram of a base station of the communication network of the communication system shown in FIG. 1;

FIG. 3 is a simplified schematic diagram of a user equipment (UE) of the communication system shown in FIG. 1;

FIG. 4A is a simplified schematic diagram showing an example of a base station forming a plurality of beams for transmitting wireless signals to a plurality of UEs;

FIG. 4B is a simplified schematic diagram showing an example of a base station using beam sweeping to cover a large geographic area and support a large number of UEs;

FIG. 5 is a simplified schematic diagram showing a conventional phased-array for beamforming and beam-steering, wherein the phased array may be part of the base station shown in FIG. 2 or part of the UE shown in FIG. 3;

FIG. 6 is a simplified schematic diagram showing a two-level antenna-array using two-level beam-steering according to some embodiments of this disclosure, wherein the phased array may be part of the base station shown in FIG. 2 or part of the UE shown in FIG. 3;

FIG. 7A is a schematic diagram showing an example of the two-level phased-array shown in FIG. 6 in the form of a planar phased-array and comprising a plurality of antenna elements arranged in a matrix form on the y-z plane;

FIG. 7B illustrates the coordinate system used in FIG. 7A;

FIGS. 8A and 8B are plots showing the antenna-gain distribution of the conventional phased-array shown in FIG. 5, wherein the phases thereof are steered to an azimuth angle ϕ=60° and a complementary elevation angle θ=30°;

FIGS. 9A and 9B are plots showing the antenna-gain distribution of an antenna group of the two-level phased-array shown in FIG. 7A, wherein the signal beam thereof is steered on the elevation plane (that is, the x-z plane) to θ=30°;

FIG. 9C shows the antenna group used in FIGS. 9A and 9B, wherein the antenna group comprises antenna elements along the z-axis;

FIGS. 10A and 10B are plots showing the antenna-gain distribution of the antenna elements along the y-axis of the two-level phased-array shown in FIG. 7A, wherein the phases thereof are steered on the azimuth plane (that is, the x-y plane) to ϕ=60°, which may be representative of the antenna gain of the antenna groups shown in FIG. 7A, wherein the phases thereof are steered on the x-y plane to ϕ=60°;

FIG. 10C shows the antenna elements used in FIGS. 10A and 10B;

FIG. 11A is a plot showing the antenna-gain distribution of a conventional 3D-steering planar phased-array shown in FIG. 11D;

FIG. 11B is a plot showing the antenna gain product of the antenna groups shown in FIG. 11E;

FIG. 11C is a plot showing the difference in dB between an antenna gain product shown in FIG. 11B and an antenna gain shown in FIG. 11A;

FIG. 11D shows the conventional planar phased-array used in FIG. 11A;

FIG. 11E shows the antenna groups shown in FIGS. 9C and 10C;

FIGS. 12A to 12D are plots showing the effect of phase quantization of the two-level phased-array shown in FIG. 7A for a θ=30° beam-steering along the elevation plane, wherein FIG. 12A shows the antenna-gain distribution when the phases are quantized to three (3) bits,

FIG. 12B shows the antenna-gain distribution when the phases are quantized to two (2) bits,

FIG. 12C shows the antenna-gain distribution when the phases are quantized to one (1) bit, and

FIG. 12D shows the antenna gain comparison of the three quantization methods shown in FIGS. 12A to 12C;

FIGS. 13A to 13D are plots showing the effect of phase quantization of the two-level phased-array shown in FIG. 7A for a θ=15° beam-steering along the elevation plane, wherein FIG. 13A shows the antenna-gain distribution when the phases are quantized to three (3) bits,

FIG. 13B shows the antenna-gain distribution when the phases are quantized to two (2) bits,

FIG. 13C shows the antenna-gain distribution when the phases are quantized to one (1) bit, and

FIG. 13D shows the antenna gain comparison of the three quantization methods shown in FIGS. 13A to 13C;

FIG. 14 is a plot showing the performance of two-bit phase quantization of the two-level phased-array shown in FIG. 7A in elevation;

FIG. 15A is a schematic perspective view of the two-level phased-array shown in FIG. 5A using a blades antenna structure and having a plurality of blade boards coupled to a motherboard, according to some embodiments of this disclosure;

FIG. 15B is a schematic cross-sectional view of the two-level phased-array shown in FIG. 15A;

FIG. 16 is a schematic diagram showing the circuit structure of a blade board of the two-level phased-array shown in FIG. 15A using phase shifters, according to some embodiments of this disclosure;

FIG. 17 is a schematic diagram showing the circuit structure of a blade board of the two-level phased-array shown in FIG. 15A using beam switches, according to some other embodiments of this disclosure;

FIG. 18 is a schematic perspective view of the two-level phased-array shown in FIG. 5A using a blades antenna structure and having a plurality of blade boards coupled to a motherboard, according to some other embodiments of this disclosure, wherein the blade boards are in a semi-circular shape of the same size, and thus the ensemble of the blade boards of the two-level phased-array is in a semi-cylindrical shape;

FIG. 19 is a schematic perspective view of the two-level phased-array shown in FIG. 5A using a blades antenna structure and having a plurality of blade boards coupled to a motherboard, according to yet some other embodiments of this disclosure, wherein the blade boards are in a semi-circular shape of different sizes, and the ensemble of the blade boards of the two-level phased-array is in a semi-spherical shape;

FIG. 20A is a schematic perspective view of the two-level phased-array shown in FIG. 5A using a blades antenna structure and having a plurality of blade boards coupled to a motherboard, according to some other embodiments of this disclosure;

FIG. 20B is a schematic plan view of the motherboard of the two-level phased-array shown in FIG. 20A;

FIG. 20C shows an exemplary control circuit connecting to the motherboard for controlling the motherboard and the blade boards for beam steering, according to some other embodiments of this disclosure;

FIG. 21 is a schematic exploded perspective view of a single-polarization, two-level phased-array shown in FIG. 5A according to some other embodiments of this disclosure;

FIG. 22 is a schematic exploded perspective view of a dual-polarization, two-level phased-array shown in FIG. 5A according to yet some embodiments of this disclosure;

FIG. 23 is a schematic perspective view of an exemplary dual-band interleaved (26 gigahertz (GHz) and 39 GHz) two-level phased-array shown in FIG. 5A according to still some embodiments of this disclosure;

FIG. 24 is a schematic perspective view of a two-level phased-array shown in FIG. 5A for forming and steering a signal beam of 72 GHz, according to some embodiments of this disclosure, wherein the plurality of blade boards comprises a plurality of waveguides;

FIG. 25 is a schematic diagram showing the transition from the motherboard to the waveguides of the blade boards shown in FIG. 24 that requires a twist structure;

FIG. 26 is a schematic diagram showing the transition from the motherboard to the waveguides of the blade boards without the twist structure, according to some embodiments of this disclosure;

FIG. 27 is a schematic perspective view of a two-level phased-array shown in FIG. 5A for forming and steering a signal beam of 72 GHZ, according to some embodiments of this disclosure, wherein the transition from the motherboard to the waveguides of the blade boards does not need the twist structure, according to some embodiments of this disclosure; and

FIG. 28 is a schematic perspective view of a two-level phased-array shown in FIG. 5A for forming and steering a signal beam of 72 GHZ, according to some other embodiments of this disclosure, wherein the transition from the motherboard to the waveguides of the blade boards does not need the twist structure, according to some embodiments of this disclosure.

### DETAILED DESCRIPTION

Embodiments disclosed herein relate to wireless systems, apparatuses, and methods using two-level beam-steering for forming signal beams. The wireless systems, apparatuses, and methods disclosed herein may be any suitable systems, apparatuses, and methods for transmitting wireless signals using signal beams. Examples of such systems, apparatuses, and methods may be the 5th generation (5G) or the 6th generation (6G) wireless mobile communication systems, apparatuses, and methods; WI-FI® systems (WI-FI is a registered trademark of Wi-Fi Alliance, Austin, TX, USA), apparatuses, and methods; radar systems, apparatuses, and methods; imaging systems, apparatuses, and methods; and the like.

As described above, beamforming and beam steering are often used in wireless systems for forming and steering a signal beam. For example, phased arrays may be used for steering a signal beam by using a plurality of phase shifters to change the phases of input signals on a plurality of antenna elements. However, in many applications wherein a large number of antenna elements are used, a large number of phase shifters are generally required for beam steering, and the control of such a large number of phase shifters may be complicated.

Herein, a two-level antenna array (such as a two-level phased array) is disclosed which may be used in various wireless systems for forming and steering a signal beam in a 3D space to simplify the control of shifting the phases of a large number of antenna elements with significantly improved output performance and reduced cost. In various embodiments, the two-level antenna array also provide other advantages, as will be illustrated in more detail below.

The two-level antenna array comprises a plurality of antenna elements partitioned into one or more antenna groups or subarrays. Each antenna element is functionally coupled to a phase shifter (denoted an “element phase-shifter”) for steering the signal beam along a first plane. Each antenna group is also functionally coupled to a phase shifter (denoted a “group phase-shifter”) for steering the signal beam along a second plane. In some embodiments, the first and second planes are mutually orthogonal.

The two-level antenna array disclosed herein thus achieves an array factor product (that is, the product of the array factor of each antenna group and the array factor for the antenna groups) which is similar to the array factor of a conventional phased array.

In some embodiments, instead of using the element phase-shifters, the two-level antenna array disclosed herein may use beam switches (denoted “element beam-switches”) for controlling the antenna elements in each antenna group to steer the signal beam along the first plane.

In some embodiments, instead of using the group phase-shifters, the two-level antenna array disclosed herein may use beam switches (denoted “group beam-switches”) for controlling the antenna groups to steer the signal beam along the second plane.

In some embodiments, the two-level antenna array disclosed herein may use a blades antenna structure for obtaining extra space for various components and for simplifying the implementation. By using the blades antenna structure, the two-level antenna array disclosed herein may comprise a primary radio-frequency (RF) circuit structure such as a primary RF circuit board (also denoted a “motherboard”) and one or more secondary RF circuit structures such as one or more secondary RF circuit board boards (also denoted “blade boards” hereinafter) coupled to the motherboard. The blade boards are configured for steering the signal beam in a first dimension (that is, along a first plane such as the elevation plane or azimuth plane) and the motherboard is configured for steering in a second dimension (that is, along a second plane such as the azimuth plane or elevation plane).

In some embodiments, the blade boards are coupled to an end of the motherboard via a plurality of end-launch connector assemblies.

In some embodiments, the blade boards comprise microstrip-line (MSL) transducers for implementing the antenna elements.

In some other embodiments, the blade boards comprise waveguides for implementing the antenna elements for reducing improve the high frequency loss associated with the feed network.

In some embodiments, the blade boards are orthogonal to the motherboard.

In some embodiments, the blade boards are parallel to the motherboard.

The two-level antenna array disclosed herein is different from Reference [1] mainly in that:
Unlike the two-level antenna array disclosed herein, Reference [1] only uses beam-switching and doesn't include phased array which is essential for better resolution, calibration and lower loss;
The two-level antenna array disclosed herein strategically optimizes the locations for active components;
The two-level antenna array disclosed herein may use waveguides for implementing the antenna elements for reducing improve the high frequency loss associated with the feed network;
The two-level antenna array disclosed herein comprises one or more heatsinks and control at optimal locations;

The two-level antenna array disclosed herein may be implemented for forming and steering a single-polarization beam or dual-polarization beams which is an important requirement in 6G base station;
The two-level antenna array disclosed herein is more compact due to the careful choice of locations and angles of the steering boards, which is important for base stations.

In the following subsections, a wireless communication system is described as an example for illustrating the two-level antenna array and two-level beam steering.

### A. System Structure

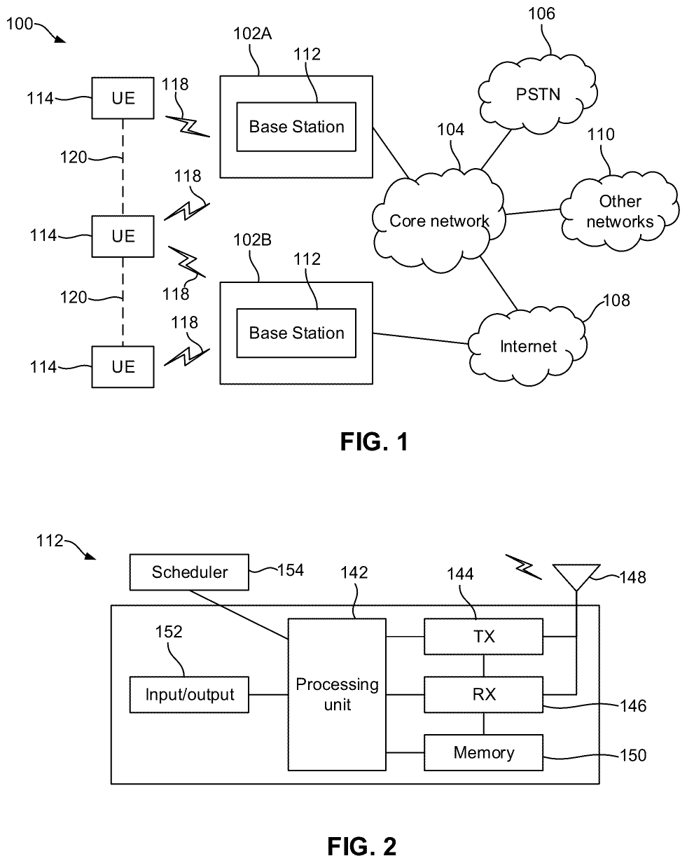

Turning now the FIG. 1, a communication system according to some embodiments of this disclosure is shown and is generally identified using reference numeral 100. The communication system 100 enables a plurality of UEs 114 to communicate data and other content, and may provide content (such as voice, data, video, text, and/or the like) via broadcast, multicast, unicast, UE-to-UE, and/or the like. The communication system 100 enables so-called multiple access of a plurality of UEs 114 by efficiently sharing communication resources such as time, frequency, and/or space resources among the UEs 114.

In these embodiments, the communication system 100 comprises two RANs 102A and 102B (each generally referred to as a RAN 102 and collectively referred to as RANs 102) connecting to a core network 104 directly or indirectly (for example, via the internet 108). The core network 104 may be in communication with one or more communication networks such as a public switched telephone network (PSTN) 106, the internet 108, and/or other networks 110. PSTN 106 may include circuit switched telephone networks for providing plain old telephone service (POTS). Internet 108 may include a network of computers and subnets (intranets) or both, and incorporate protocols, such as Internet Protocol (IP), Transmission Control Protocol (TCP), User Datagram Protocol (UDP), and/or the like.

The RANs 102A and 102B communicate with the UEs 114 to enable the UEs 114 to operate and/or communicate in the communication system 100, or more specifically, to communicate with the core network 104, the PSTN 106, the internet 108, other networks 110, or any combination thereof. The RANs 102 and/or the core network 104 may be in direct or indirect communication with one or more other RANs (not shown), which may or may not be directly served by the core network 104, and may or may not employ the same radio access technology as RAN 102A, 102B, or both. The core network 104 may also serve as a gateway access between (i) the RANs 102 or UEs 114 or both, and (ii) other networks (such as the PSTN 106, the internet 108, and the other networks 110).

Each RAN 102 comprises one or more base stations 112 and is configured to wirelessly connect with one or more UEs 114 to enable access to any other base stations 112, the core network 104, the PSTN 106, the internet 108, and/or the other networks 110. Herein, the base stations 112 and the UEs 114 may be considered as different types of network nodes (or simply “nodes”) of the communication system 100. A base station 112 (otherwise referred to as a radio access node (RAN node) forms part of the RAN 102, which may include other base stations 112, base station controllers (BSCs), radio network controllers (RNCs), relay nodes, elements, and/or devices. A base station 112 may comprise or may be a device in any suitable form such as a base transceiver station (BTS), a Node-B (NodeB), an evolved NodeB (eNodeB), a Home eNodeB, a gNodeB or gNB (next generation NodeB, sometimes called a “gigabit” NodeB), a transmission point (TP), a transmit/receive point (TRP), a site controller, an access point (AP), a wireless router, or the like. A base station 112 may otherwise be referred to herein as a RAN node. Moreover, a base station 112 may be a single element, as shown in FIG. 1, or comprise a plurality of elements distributed in a corresponding RAN 102. Each base station 112 transmits and/or receives wireless signals within a particular geographic region or area, sometimes referred to as a “cell” or “coverage area”. A cell may be further divided into cell sectors, and a base station 112 may, for example, employ a plurality of transmitting modules, receiving modules, and/or transceivers (which are generally a combination of transmitting and receiving modules) to provide service to multiple sectors. In some embodiments, there may be established pico or femto cells where the radio access technology supports such. In some embodiments, a plurality of transceivers may be used for each cell, for example using multiple-input multiple-output (MIMO) technology. The number of RANs 102 shown in FIG. 1 is exemplary only. Any number of RANs 102 may be contemplated when devising the communication system 100.

FIG. 2 is a simplified schematic diagram of a base station 112. As shown, the base station 112 comprises at least one processing unit 142, at least one transmitting (TX) module 144, at least one receiving (RX) module 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the base station 112.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each TX module 144 may comprise any suitable structure for generating signals, such as control signals as described in detail below, for wireless transmission to one or more UEs 114 or other devices. Each RX module 146 may comprise any suitable structure for processing signals received wirelessly from one or more UEs 114 or other devices. Although shown as separate components, at least one TX module 144 and at least one RX module 146 may be integrated and implemented as a transceiver. Each antenna 148 may comprise any suitable structure for transmitting and/or receiving wireless signals. Although a common antenna 148 is shown in FIG. 2 as being coupled to both the TX module 144 and the RX module 146, one or more antennas 148 may be coupled to the TX module 144, and one or more separate antennas 148 may be coupled to the RX module 146.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by a base station 112 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 1, the base stations 112 of the RANs 102 may communicate with the UEs 114 via Uu links 118 which may be any suitable wireless communication links such as RF links, microwave links, infrared (IR) links, and/or the like. The UEs 114 may communicate with the base stations 112 via Uu links 118 using any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The Uu links 118 may use any suitable radio access technologies such as universal mobile telecommunication system (UMTS), high speed packet access (HSPA), HSPA+ (optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1X, CDMA2000 EV-DO, IS-2000, IS-95, IS-856, global system for mobile communications (GSM), enhanced data rates for GSM evolution (EDGE), GSM EDGE radio access network (GERAN), 5G New Radio (5G NR), standard or non-standard satellite internet access technologies, and/or the like. Herein, a communication from a RAN 102 or a base station 112 thereof to a UE 114 is denoted as a downlink (DL) communication and a communication from a UE 114 to a RAN 102 or a base station 112 thereof is denoted as an uplink (UL) communication. Accordingly, a channel used for a downlink communication is a DL channel and a channel used for an uplink communication is a UL channel.

Herein, the UEs 114 may be any suitable wireless device that may join the communication system 100 via a RAN 102 for wireless operation. In various embodiments, a UE 114 may be a wireless electronic device used by a human or user (such as a smartphone, a cellphone, a personal digital assistant (PDA), a laptop, a computer, a tablet, a smart watch, a consumer electronics device, and/or the like). A UE 114 may alternatively be a wireless sensor, an Internet-of-things (IoT) device, a robot, a shopping cart, a vehicle, a smart TV, a smart appliance, a wireless transmit/receive unit (WTRU), a mobile station, a fixed or mobile subscriber unit, a machine type communication (MTC) device, or the like. Depending on the implementation, the UE 114 may be movable autonomously or under the direct or remote control of a human, or may be positioned at a fixed position.

In some embodiments, a UE 114 may be a multimode wireless electronic device capable of operation according to multiple radio access technologies and incorporate multiple transceivers necessary to support such.

In addition, some or all of the UEs 114 comprise functionality for communicating with different wireless devices and/or wireless networks via different wireless links using different wireless technologies and/or protocols. Instead of wireless communication (or in addition thereto), the UEs 114 may communicate via wired communication channels to other devices or switches (not shown), and to the Internet 108. For example, as shown in FIG. 1, a plurality of the UEs 114 (such as UEs 114 in proximity with each other) may communicate with each other directly via suitable wired or wireless sidelinks 120. Accordingly, a wired or wireless channel of a wired or wireless sidelink 120 is denoted a sidelink channel.

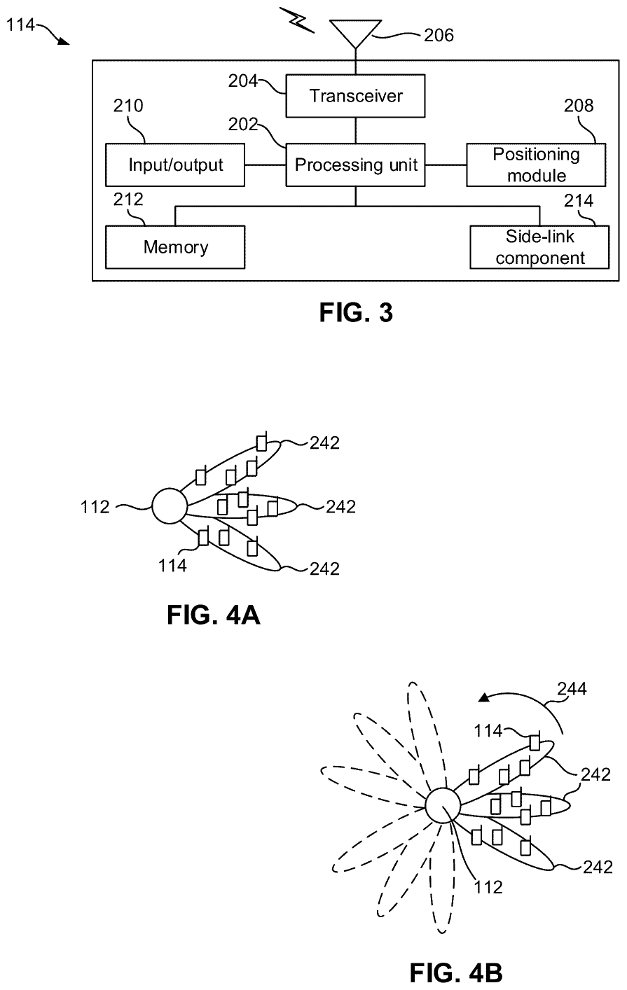

FIG. 3 is a simplified schematic diagram of a UE 114. As shown, the UE 114 comprises at least one processing unit 202, at least one transceiver 204, at least one antenna or network interface controller (NIC) 206, at least one positioning module 208, one or more input/output components 210, at least one memory 212, and at least one sidelink component 214.

The processing unit 202 is configured for performing various processing operations such as signal coding, data processing, power control, input/output processing, or any other functionalities to enable the UE 114 to access and join the communication system 100 and operate therein. The processing unit 202 may also be configured to implement some or all of the functionalities of the UE 114 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with a RAN 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitting module and at least one receiving module.

The positioning module 208 is configured for communicating with a plurality of global or regional positioning devices such as navigation satellites for determining the location of the UE 114. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the UE 114.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the UE 114 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one sidelink component 214 is configured for communicating with other devices such as other UEs 114 via suitable sidelinks 120. A wireless sidelink 120 may be a radio link, a WI-FI® link, a BLUETOOTH® link (BLUETOOTH is a registered trademark of Bluetooth Sig Inc., Kirkland, WA, USA), and/or the like. A wired sidelink 120 may be a connection established between two UEs 114 using a USB cable, a network cable, a parallel cable, a serial cable, and/or the like.

In the following, the base stations 112 and UEs 114 are generally classified as transmitters and receivers, wherein a base station 112 may be a transmitter when it is transmitting a wireless signal or a receiver when it is receiving a wireless signal. Similarly, a UE 114 may be a transmitter when it is transmitting a wireless signal or a receiver when it is receiving a wireless signal.

In these embodiments, the base station 112 or the UE 114 or both may comprise a plurality of antennas or antenna elements 148 or 206. As known in the art, multiple antennas at the transmitter side or the receiver side or both transmitter and receiver sides may be used to provide diversity against channel fading. More specifically, the communication system 100 may exploit the fact that the channels experienced by different antennas may be at least partly uncorrelated due to for example, sufficient inter-antenna distance and/or different polarization between the antennas.

By carefully adjusting the phase and/or the amplitude of each antenna, multiple antennas at the transmitter side may be used to provide signal directivity by directing the overall power of the transmitted wireless signals along one or more directions thereby forming one or more so-called signal beams (or simply “beams”), or more generally, towards specific locations in space. In the following, a beam formed by the transmitter is also denoted a transmitter beam.

The directivity of a beam may increase the achievable transmission data rates and range/coverage due to increased power reaching the target receiver. Such directivity may also reduce the interference to other links thereby improving the overall spectrum efficiency. FIG. 4A shows an example of a base station 112 forming a plurality of beams 242 for transmitting wireless signals to a plurality of UEs 114. Each beam 242 may service a plurality of UEs 114, and the number of UEs 114 serviced by a beam 242 may be large, for example, in applications where UEs 114 in the form of machine type communication (MTC) devices are densely deployed in a smaller area or direction.

When beam forming is used, the coverage of the wireless signal is reduced because the wireless signal is generally focused about a certain direction or a geographic location in space. Often, there is a need to steer or change the direction of the beam. For example, as shown in FIG. 4B, beam sweeping may be used to cover a large geographic area and support a large number of UEs 114 by directing one or more beams 242 to different directions and change the directions over time (for example, rotating the beams 242 along the direction indicated by the arrow 244) to cover a large geographic area or space.

### B. Two-Level Beam Steering

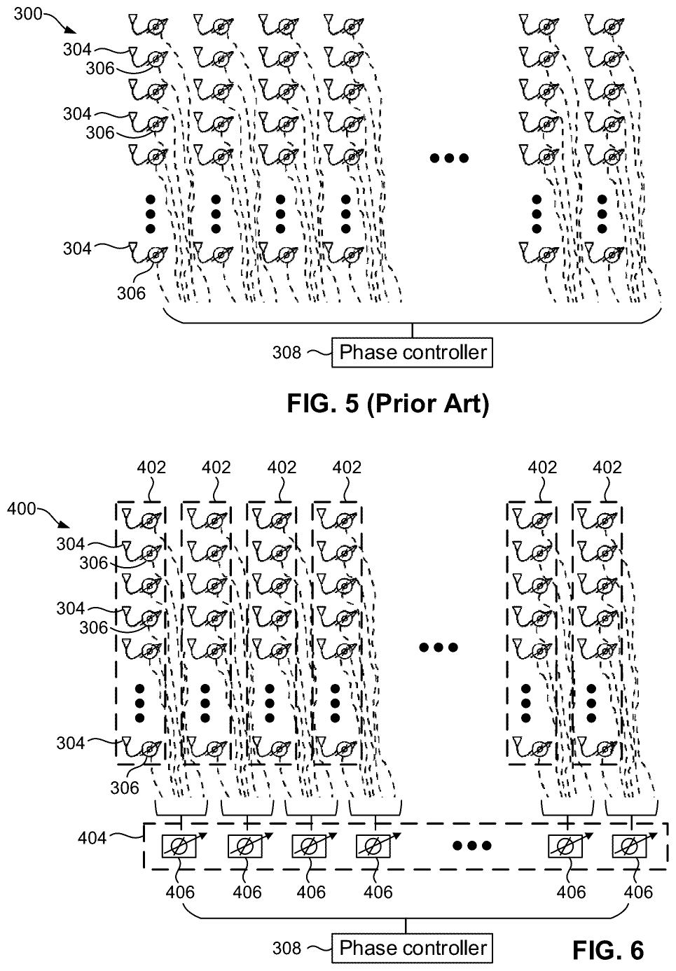

FIG. 5 is a schematic diagram of a conventional phased array 300 that uses discrete components. As shown, the phased array 300 comprises a plurality of antenna elements 304 arranged in an M×N matrix (having M rows and N columns) such as a 16×16 matrix. Each antenna element 304 is functionally coupled to a respective phase shifter 306. The plurality of phase shifters 306 are functionally coupled to a phase-control circuit 308 (also called a “phase controller” hereinafter). In this example, the phased array 300 may be part of the TX 144 of a base station 112 and the antenna elements 304 may the antenna elements 148 of the base station 112 (see FIG. 2). Alternatively, the phased array 300 may be part of the transceiver 204 of a UE 114 and the antenna elements 304 may the antenna elements 206 of the UE 114 (see FIG. 3).

In this example, the phase controller 308 controls the phase shifters 306 to change the phases of input signals on the antenna elements 304 for forming a signal beam towards a desired direction and for steering the direction of the signal beam on a predefined plane (denoted “two-dimensional (2D) beam steering”) or towards any direction in the three-dimensional (3D) space (denoted “3D beam steering”). For example, a 6G base station 112 may use discrete components with narrow beams steerable in two planes (denoted azimuth and elevation) of the 3D space. In prior art, 3D beam steering is usually obtained by planar phased array. However, the control of large planar phased-array antenna (which comprises a large number of phase shifters 306) is complex due to large number of phase shifters.

In the conventional phased array 300, each phase shifter 306 is individually controlled by the phase controller 308. As a phased array 300 may comprise a large number of antenna elements (such as hundreds of antenna elements), the conventional phased array 300 may require a large number of control signals. More specifically, for a conventional, planar phased-array 300 having M×N antenna elements with each phase shifter using B number of bits, the total number of bits used to control the beam is M×N×B. For example, a conventional, planar phased-array 300 having 32×32 (that is, 1024) antenna elements requires independently controlling 1024 phase shifters (at least two (2) bits each) for beamforming, which implies routing and driving at least 2048 signal lines at a high speed. With a high number of control signals, the conventional phased array 300 may also require complex control and calibration. Moreover, the component density of the conventional phased array 300 may be high.

FIG. 6 is a schematic diagram of an antenna array 400 (denoted a “two-level antenna-array”) in the form of a phased array using two-level beam-steering (denoted a “two-level phased-array”), according to some embodiments of this disclosure. The two-level phased-array 400 comprises a plurality of antenna elements 304 arranged in a M×N matrix (having M rows and N columns) such as a 16×16 matrix. Each antenna element 304 is functionally coupled to a beam-steering component 306 which in these embodiments is a phase shifter (denoted “element phase-shifter” for differentiating from the group phase-shifter 406 to be described below), for the first-level beam-steering. The plurality of antenna elements 304 are partitioned into one or more antenna groups 402 (also denoted “sub-arrays”). Each antenna group 402 is also functionally coupled to a respective beam-steering component 406 which in these embodiments is a phase shifter (denoted “group phase-shifter” for differentiating from the element phase-shifter 306) of a second-level beam-steering module 404. A phase controller 308 is coupled to the phase shifters 306 and 406 for beamforming and beam steering.

In beam steering, the phase controller 308 controls the element phase-shifters 306 associated with the antenna elements 304 of each antenna group 402 for 2D beam-steering on a predefined first plane (that is, changing a first angle of the beam along the predefined first plane). The phase controller 308 also controls each group phase-shifter 406 for 2D beam-steering on a predefined second plane (that is, changing a second angle of the beam along the predefined second plane). In this manner, the two-level phased-array 400 achieves an array factor product.

In some embodiments, the first and second planes are mutually orthogonal.

As a comparison, in order to steer the signal beam 30° in elevation (which means a progressive phase shift of −90° in half-wavelength spaced antenna array) and 60° in azimuth (which corresponds to a progressive phase shift of 155.88°), the phase settings of the conventional phased-array shown in FIG. 5 are listed in Table 1 below:

TABLE 1
PHASE SETTINGS OF THE CONVENTIONAL PHASED−ARRAY FOR STEERING
THE SIGNAL BEAM 30° IN ELEVATION AND 60° IN AZIMUTH (UNIT: DEGREE)

| | | | | | | | |
|---|---|---|---|---|---|---|---|
| −245.7 | −401.8 | −197.6 | −353.7 | −149.4 | −305.2 | −101.3 | −257.0 |
| −335.7 | −491.8 | −287.6 | −443.7 | −239.4 | −395.2 | −191.3 | −347.0 |
| −425.7 | −581.8 | −377.6 | −533.7 | −329.4 | −485.2 | −281.3 | −437.0 |
| −155.7 | −311.8 | −107.6 | −263.7 | −59.4 | −215.2 | −11.3 | −167.0 |
| −245.7 | −401.8 | −197.6 | −353.7 | −149.4 | −305.2 | −101.3 | −257.0 |
| −335.7 | −491.8 | −287.6 | −443.7 | −239.4 | −395.2 | −191.3 | −347.0 |
| −425.7 | −581.8 | −377.6 | −533.7 | −329.4 | −485.2 | −281.3 | −437.0 |
| −155.7 | −311.8 | −107.6 | −263.7 | −59.4 | −215.2 | −11.3 | −167.0 |

On the other hand, the phase settings of the two-level phased-array shown in FIG. 6 for steering the signal beam 30° in elevation and 60° in azimuth are listed in Table 2 below:

TABLE 2
PHASE SETTINGS OF THE TWO−LEVEL PHASED−ARRAY FOR STEERING THE
SIGNAL BEAM 30° IN ELEVATION AND 60° IN AZIMUTH (UNIT: DEGREE)
(I) PHASE SETTINGS OF ELEMENT PHASE−SHIFTERS

| | | | | | | | |
|---|---|---|---|---|---|---|---|
| −90.0 | −90.0 | −90.0 | −90.0 | −90.0 | −90.0 | −90.0 | −90.0 |
| −180.0 | −180.0 | −180.0 | −180.0 | −180.0 | −180.0 | −180.0 | −180.0 |
| −270.0 | −270.0 | −270.0 | −270.0 | −270.0 | −270.0 | −270.0 | −270.0 |
| 0.0 | 0.0 | 0.0 | 0.0 | 0.0 | 0.0 | 0.0 | 0.0 |
| −90.0 | −90.0 | −90.0 | −90.0 | −90.0 | −90.0 | −90.0 | −90.0 |
| −180.0 | −180.0 | −180.0 | −180.0 | −180.0 | −180.0 | −180.0 | −180.0 |
| −270.0 | −270.0 | −270.0 | −270.0 | −270.0 | −270.0 | −270.0 | −270.0 |
| 0.0 | 0.0 | 0.0 | 0.0 | 0.0 | 0.0 | 0.0 | 0.0 |

(II) PHASE SETTINGS OF GROUP PHASE−SHIFTERS

| | | | | | | | |
|---|---|---|---|---|---|---|---|
| −155.7 | −311.8 | −107.6 | −263.7 | −59.4 | −215.2 | −11.3 | −167.0 |

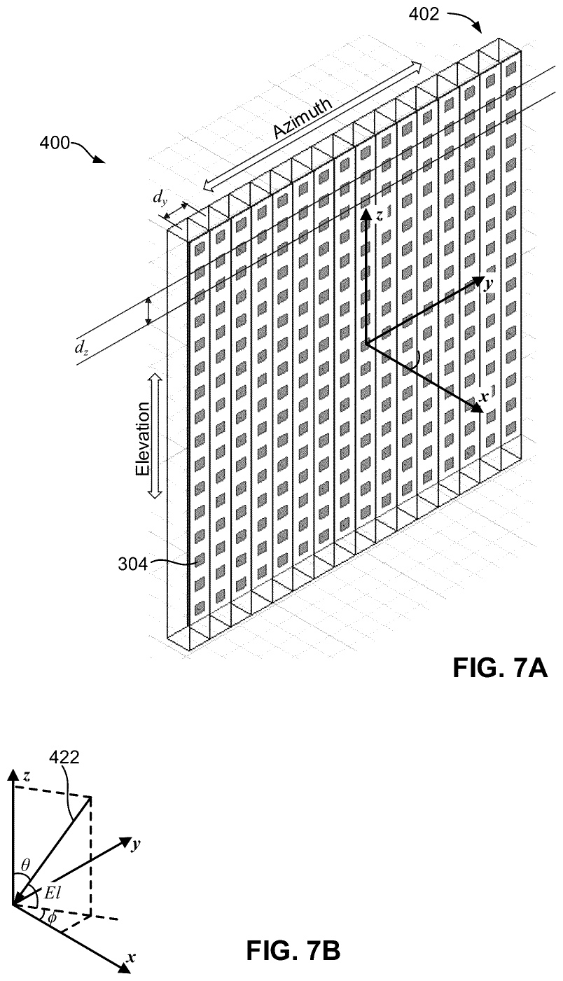

FIG. 7A shows an example of the two-level phased-array 400 in the form of a planar phased-array and comprising a plurality of antenna elements arranged in a matrix form on the y-z plane. The spacing of the antenna elements along the y-axis is d_{y} and the spacing of the antenna elements along the z-axis is d_{z}. Also referring to FIG. 7B, in this example, the first plane may be the elevation plane (also simply denoted the “elevation”), that is, the x-z plane, and the second plane may be the azimuth plane (also simply denoted the “azimuth”), that is, the x-y plane. The elevation plane and the azimuth plane are mutually orthogonal.

Accordingly, the azimuth angle (denoted “Az” or “ϕ”) is an angle defined between the x-axis and the projection of a plane-wave signal 422 on the x-y plane. The elevation angle (denoted “El”) is an angle defined between the plane-wave signal 422 and its projection on the x-y plane. The complementary elevation angle θ is defined as the angle between the plane-wave signal 422 and the z-axis.

Each antenna element 304 is coupled to an element phase-shifter 306 (not shown). The antenna elements 304 (and accordingly the element phase-shifters 306) are partitioned to a plurality of antenna groups 402 with each antenna group 402 comprising a plurality of antenna elements 304 and the corresponding element phase-shifters 306 along the z-axis. Thus, the plurality of antenna groups 402 are distributed along the y-axis.

In each antenna group 402, the antenna elements 304 thereof are controlled by the corresponding element phase-shifters 306 to steer the elevation angle of the signal beam (along the elevation plane). The group phase-shifters 406 (not shown in FIG. 7A) controls the antenna groups 402 to steer the azimuth angle of the signal beam (along the azimuth plane).

Then, the phase of the antenna weight for the antenna groups 402 is

$${kd}_{y} cos ( El ) sin ( Az ) = {kd}_{y} sin θ sin ϕ , \qquad ( 1 )$$

and the phase of the antenna weight for the antenna elements in each antenna group 402 is

$${kd}_{Z} sin ( El ) = {kd}_{Z} cos θ , \qquad ( 2 )$$

where k is the wavenumber.

Equation (2) shows that the phase of the antenna weight for the antenna elements in each antenna group 402 is independent of the azimuth angle ϕ. Accordingly, the phase shifters in each antenna group 402 may have the same elevation steering setting.

The array factor AF_{z} of each antenna group 402 is:

$${AF}_{z} = {\sum }_{{n}_{z}}^{{N}_{z}} {e}^{i ( {n}_{z} {kd}_{z} cos θ )} \qquad ( 3 )$$

where n_{z} is the index of an antenna element in the antenna group 402, and N_{z} is the total number of the antenna elements in the antenna group 402.

The array factor AF_{y} of the antenna groups 402 is:

$${AF}_{y} = {\sum }_{{n}_{y}}^{{N}_{y}} {e}^{i ( {n}_{y} {kd}_{y} cos θ sin ϕ )} \qquad ( 4 )$$

where n_{y} is the index of an antenna group 402, and N_{y} is the total number of the antenna groups 402.

Thus, the array factors product is:

$${AF}_{z} \times {AF}_{y} = {\sum }_{{n}_{z}}^{{N}_{z}} {e}^{i ( {n}_{z} {kd}_{z} cos θ )} \times {\sum }_{{n}_{y}}^{{N}_{y}} {e}^{i ( {n}_{y} {kd}_{y} sin θ sin ϕ )} \qquad ( 5 )$$

which is the same as the 2D array factor:

$${AF}_{yz} = {\sum }_{{n}_{z}}^{{N}_{z}} {\sum }_{{n}_{y}}^{{N}_{y}} {e}^{i ( {n}_{z} {kd}_{z} cos θ + {n}_{y} {kd}_{y} sin θ sin ϕ )} . \qquad ( 6 )$$

Therefore, the planar two-level phased-array 400 is a uniform phased-array.

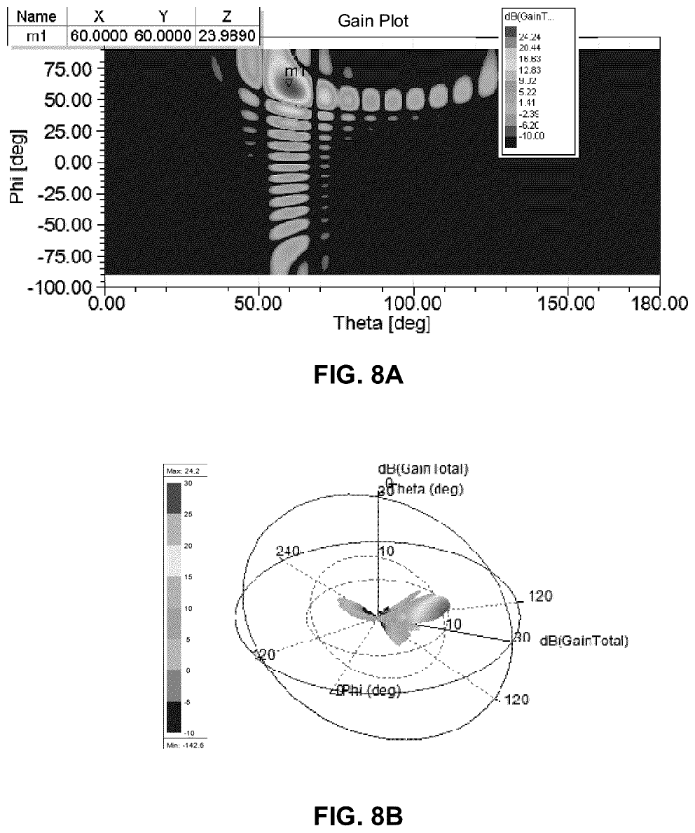

FIGS. 8A and 8B are plots showing the antenna-gain distribution of a conventional 3D-steering phased-array 300, wherein the phases thereof are steered to ϕ=60° and θ=30°.

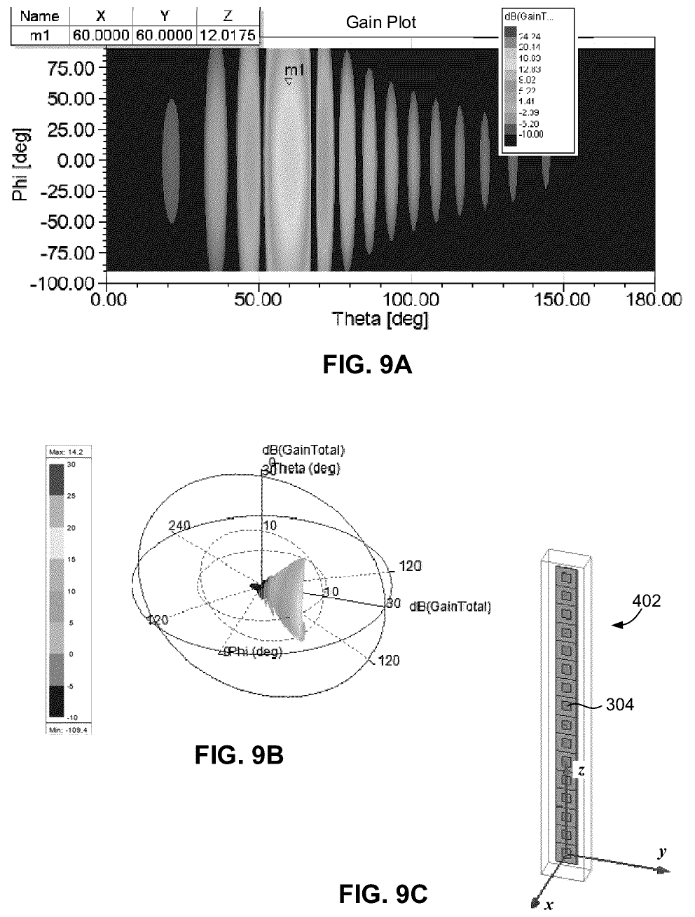

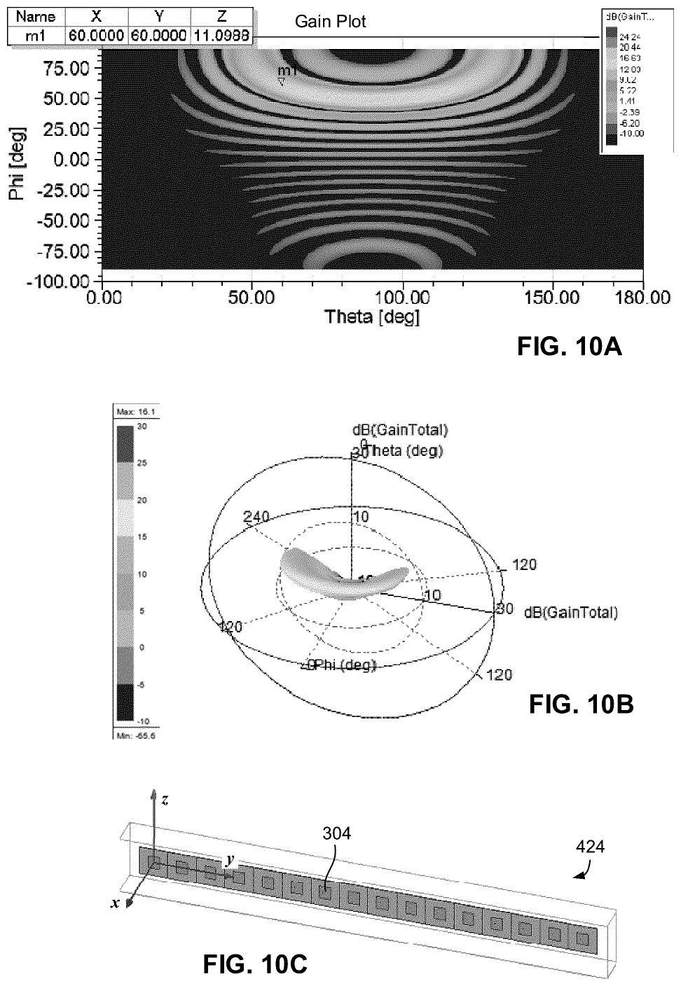

FIGS. 9A and 9B are plots showing the antenna-gain distribution of an antenna group 402 (having antenna elements along the z-axis; see FIG. 9C) of a two-level phased-array 400, wherein the signal beam thereof is steered on the elevation plane (that is, the x-z plane) to θ=30°. FIGS. 10A and 10 B are plots showing the antenna-gain distribution of a group 424 of the antenna elements along the y-axis (see FIG. 10C) of a two-level phased-array 400, wherein the phases thereof are steered on the azimuth plane (that is, the x-y plane) to ϕ=80°.

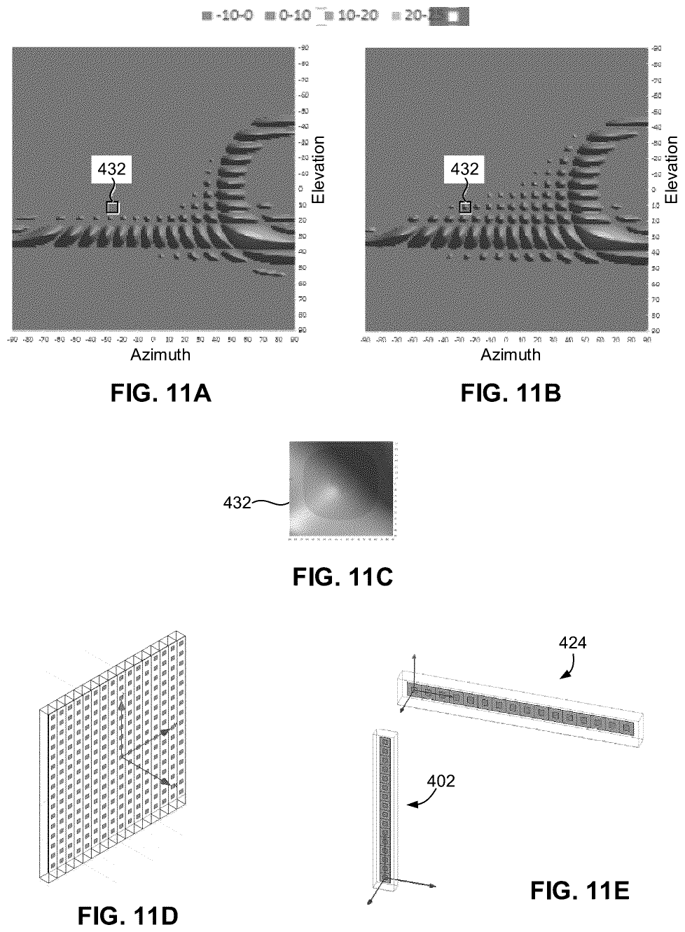

As a comparison, FIG. 11A is a plot showing the antenna-gain distribution of a conventional 16×16, 3D-steering planar phased-array 300′ (that is, having 16 phase shifters in each row and 16 phase shifters in each column) as shown in FIG. 11D, which is the multiplication of the array factor and the antenna-element gain thereof.

FIG. 11B is a plot showing the antenna gain product in dB of the 16×1 antenna group 402′ (that is, 16 rows, each row having one phase shifter) and the 1×16 antenna group 424′ (that is, one row having 16 phase shifters) as shown in FIG. 11E (similar to antenna groups 402 and 424 shown in FIGS. 9C and 10C), which may represent the antenna-gain distribution pattern of a 16×16 two-level phased-array 400. The antenna gain product shown in FIG. 11B is the multiplication of the antenna gains of the antenna groups 402′ and 424′, which is also the multiplications of the azimuth one-dimensional (1D) array factor of the antenna group 424′, the antenna-element gain of the antenna group 424′, the elevation 1D array factor of the antenna group 402′, and the antenna-element gain of the antenna group 402′, which is also the multiplications of the array factor of the conventional phased array, the antenna-element gain of the antenna group 424′, and the antenna-element gain of the antenna group 402′.

As can be seen, the antenna gain product shown in FIG. 11B generally equals to the antenna gain shown in FIG. 11A times the antenna gain 432 shown FIG. 11C (in other words, the antenna gain 432 shown FIG. 11C represents the difference in dB between the antenna gain product shown in FIG. 11B and the antenna gain shown in FIG. 11A). Thus, the antenna-gain distribution pattern of the two-level phased-array 400 is similar to that of the conventional 3D-steering phased-array 300.

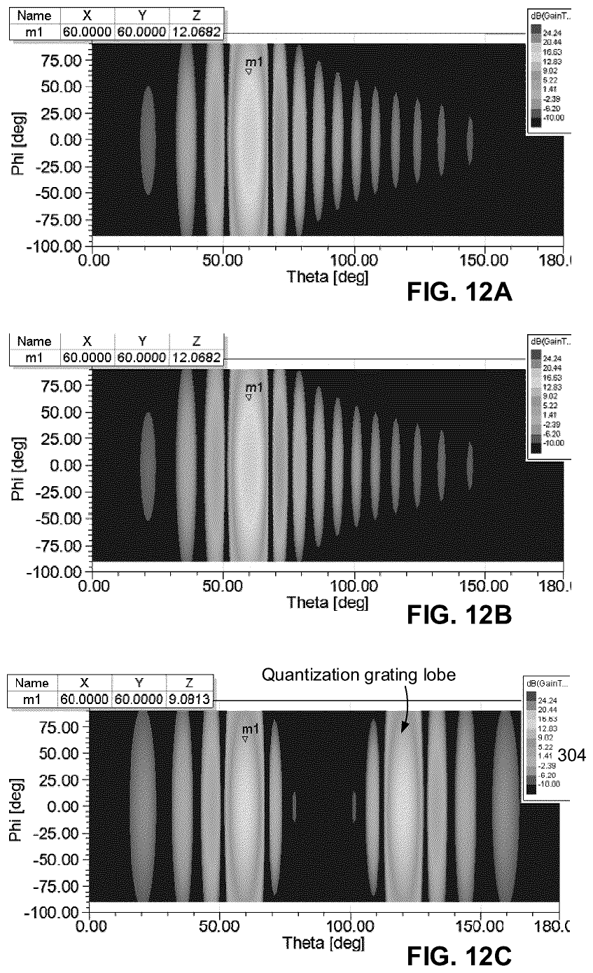

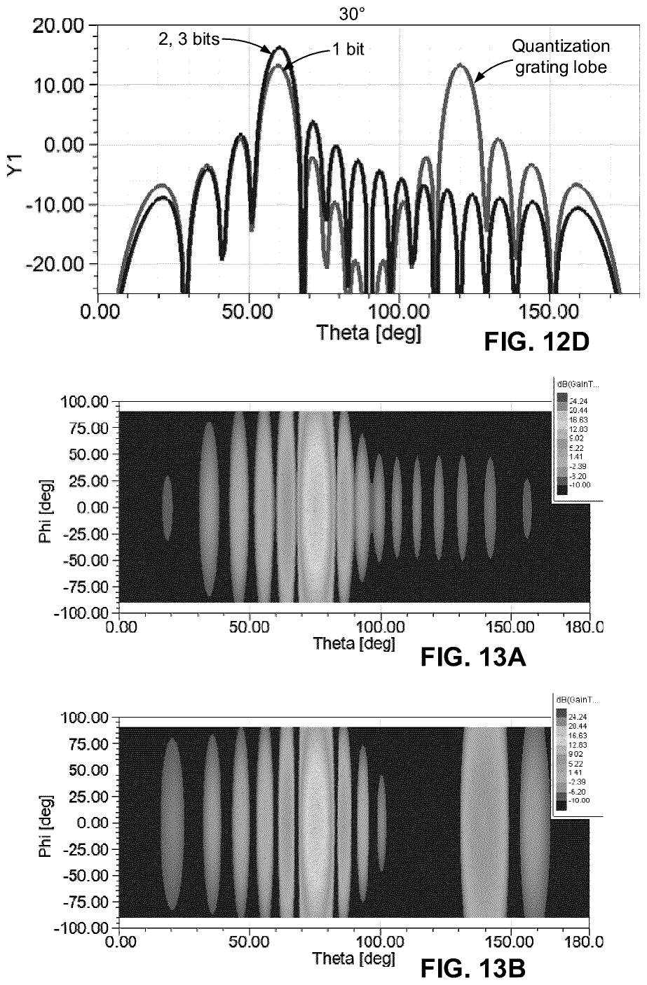

FIGS. 12A to 14 show the effects of three-bit, two-bit, and one-bit phase quantizations of the two-level phased-array 400, wherein each phase shifter 306, 406 has three (3) bits, two (2) bits, and one (1) bit, respectively. As can be seen from these figures, the quantization effects start to appear at two-bit quantization, and one-bit quantization may be less likely acceptable.

FIGS. 12A to 12D are plots showing the effect of phase quantization of the two-level phased-array 400 for a θ=30° beam-steering along the elevation plane, wherein FIG. 12A shows the antenna-gain distribution when the phases are quantized to three (3) bits, FIG. 12B shows the antenna-gain distribution when the phases are quantized to two (2) bits, FIG. 12C shows the antenna-gain distribution when the phases are quantized to one (1) bit, and FIG. 12D shows the antenna gain comparison of the three quantization methods. As can be seen that the effects of two-bit quantization and three-bit quantization are similar. However, one-bit quantization gives rise to a large quantization grating lobe.

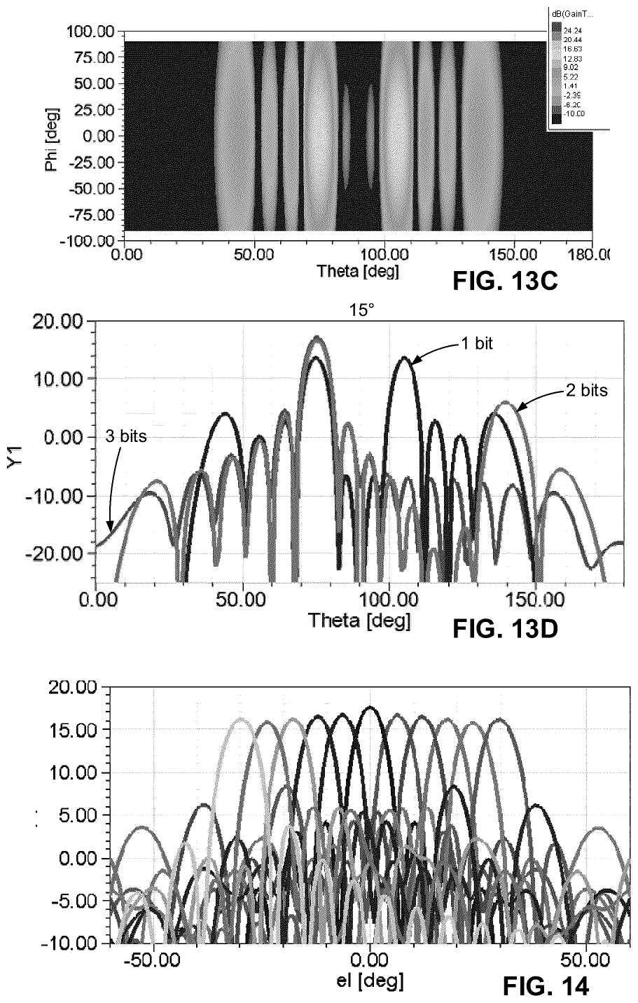

FIGS. 13A to 13D are plots showing the effect of phase quantization of the two-level phased-array 400 for a θ=15° beam-steering along the elevation plane, wherein FIG. 13A shows the antenna-gain distribution when the phases are quantized to three (3) bits, FIG. 13B shows the antenna-gain distribution when the phases are quantized to two (2) bits, FIG. 13C shows the antenna-gain distribution when the phases are quantized to one (1) bit, and FIG. 13D shows the antenna gain comparison of the three quantization methods.

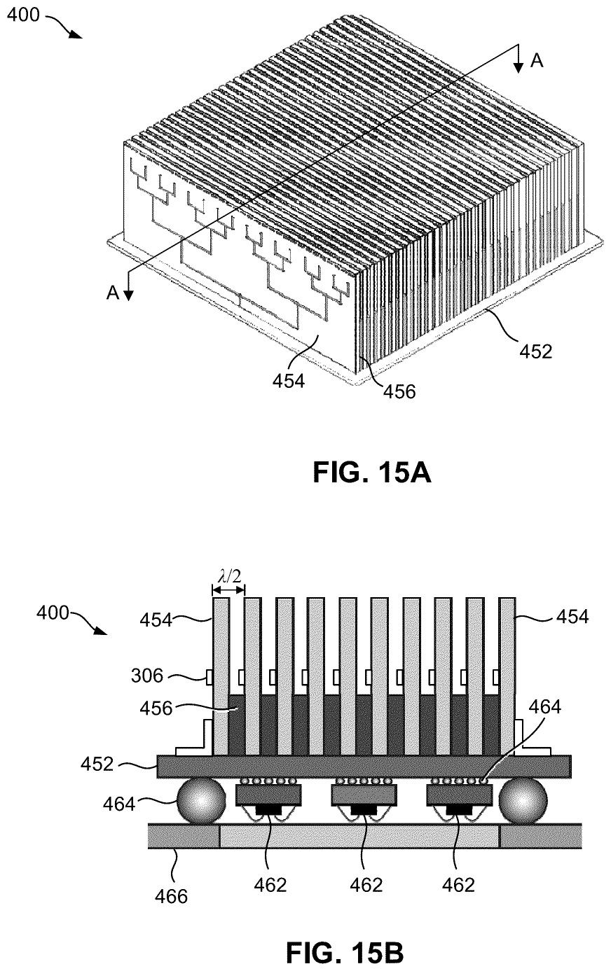

FIG. 14 is a plot showing the performance of two-bit phase quantization of the two-level phased-array 400 in elevation. In the worst case, the side-lobe level (SLL) is about 8.5 dB which may be reduced with tapering.

By efficiently combining beam switching of antenna elements in each antenna group along one plane (for example, elevation or azimuth) and beam switching of antenna groups along the other plane (for example, azimuth or elevation), the two-level beam-steering disclosed herein may achieve 3D scanning or beam-steering with optimized antenna control (with reduced complexity), size, and power consumption.

### C. Blades Antenna Structure

In some embodiments, the two-level phased-array 400 uses a blades antenna structure and comprises a primary RF circuit structure such as a primary RF circuit board 452 (also denoted a “motherboard” hereinafter) and one or more secondary circuit structures such as one or more secondary circuit boards 454 (also denoted “blade boards” hereinafter) coupled to the motherboard 452. The blade boards 454 comprises the antenna elements 304 and the element phase-shifters 306 for steering the signal beam in a first dimension (that is, along a first plane such as the elevation plane or azimuth plane). The motherboard 452 comprises the group phase-shifters 406 and other necessary components for steering the signal beam in a second dimension (that is, along a second plane such as the azimuth plane or elevation plane).

For example, as shown in FIGS. 15A and 15B, the two-level phased-array 400 comprises a motherboard 452 and a plurality of blade boards 454 coupled to one side of the motherboard 452 and with an orientation normal or perpendicular thereto. The blade boards 454 are spaced from each other with a spacing of λ/2 (where λ is the wavelength of the wireless signal) and are coupled to the motherboard 452 via suitable coupling methods such as RF connectors, substrate-integrated waveguides (SIWs), soldering, and/or the like. One or more spacers 456 are sandwiched between adjacent blade boards 454 for securing the blade boards 454 in place.

The motherboard 452 comprises a plurality of active components 462 such as transceiver (TRX) power amplifiers (PFs), low-noise amplifiers (LNAs), RF single-pole double-throw (SPDT) switches, mixers, the group phase-shifters (PSs) 406, and/or the like. Thus, a careful thermal analysis for the mother board is generally required. The active components 462 may be attached directly to the motherboard 452 using wire-bonds, flip-chipped, and/or wire-bond ball-grid arrays (BGA) packages 464 (which place output pins in the form of a solder ball matrix). In the example shown in FIG. 15B, the motherboard 452 is connected through BGAs 464 to another circuit board 466 such as an intermediate frequency (IF) board, a control board, a power board, or the like. Of course, those skilled in the art will appreciate that, in some embodiments, the motherboard 452 may also comprise necessary circuits for IF processing, control, and power, and thus does not need the circuit board 466.

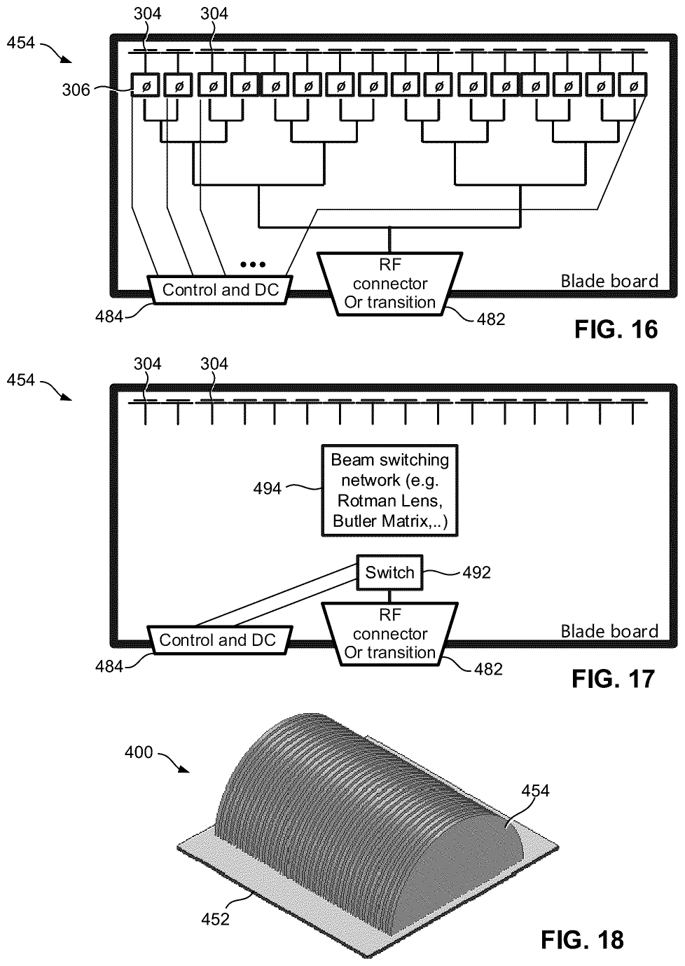

Each blade board 454 comprises the antenna elements 304 and the corresponding beam-steering switches or element phase-shifters 306 of an antenna group 402. As shown in the example of FIG. 16, the blade board 454 comprises a plurality of linearly-arranged end-fire antenna elements 304 implemented using printed circuit board (PCB) technology. Each end-fire antenna elements 304 is connected to a respective element phase-shifter 306. The element phase-shifters 306 are connected to the motherboard 452 via, for example, a RF connector 482. The element phase-shifters 306 may also be connected to a control and direct-current (DC) module 484 (having necessary components such power splitter/combiner) for connecting to a corresponding control and DC module of the motherboard 452.

In some embodiments, the element phase-shifters 306 of the blade board 454 have same settings. In some other embodiments, the element phase-shifters 306 of all blade boards 454 of the two-level phased-array 400 have same settings.

By using element phase-shifters 306 of same settings, the hardware and control of the blade board 454 may be significant simplified. Consequently, the blade board 454 may be much simpler than the motherboard 452, thereby significantly improving the output performance of the two-level phased-array 400, and reducing the control complexity and the cost thereof. Moreover, with the use of the blades antenna structure, the two-level phased-array 400 may not need cooling.

As those skilled in the art will appreciate, the blades antenna structure provides extra space (that is, the third dimension of the antenna structure/depth) that allows for more features such as dual band, broad band, and conformal arrays. More specifically, the two-level phased-array 400 disclosed herein provides various advantages such as:
by dividing the beam-steering circuit board into azimuth-steering and elevation-steering boards, the stack-up and circuit routing are simplified thereby significantly improving output performance of the two-level phased-array 400 and reducing the cost thereof;
the blades antenna structure provides a modular structure allowing testing and/or calibrating each stage and/or part separately and allowing a mix-and-match method (that is, using different antennas, beam-steering methods, transitions, and/or the like in a two-level phased-array 400);
using blade boards leverages another dimension (that is, the third dimension compared to conventional planar circuit boards) which is otherwise limited to multi-layer printed circuit board (PCB) restrictions;
the blades antenna structure exploits the third dimensions of antenna which improves the components density and allows for arbitrary array shape (for example, conformal array);
the phase shifters of all blade boards 454 have the same settings which significantly simplifies the hardware and control of the two-level phased-array 400;
for base-station applications, the field of view in the azimuth plane is usually greater than the elevation plane resulting in more beams, and correspondingly this two-level phased-array 400 enables hybridizing the 3D beam-steering by using beam-switching for one plane (which may be advantageous for lower number of beams) and phased array for the other plane (which is advantageous for higher number of beams); and
the phase-shifter requirements (mainly the resolution/number of bits) are much simpler than conventional phased arrays.

Although in above embodiments, spacers are used for securing the blade boards 454 to the motherboard 452, in some alternative embodiments, the two-level phased-array 400 does not use spacers between blade boards 454.

In some embodiments as shown in FIG. 17, the blade board 454 uses beam switching rather than phase shifters. More specifically, the antenna elements 304 of the blade board 454 are connected to beam switches 492 via a beam-switching network 494 such as Rotman lens, Butler matrix, or the like. In these embodiments, the blade board 454 also comprises a RF connector 482 for coupling to the motherboard 452 and a control and DC module 484 for control and powering. The blade board 454 in these embodiments may be suitable or advantageous for small number of beams such as 20 beams or less.

In some embodiments, the group phase-shifters 406 may be located on the motherboard 452. In some embodiments, instead of using the group phase-shifters 406, the motherboard 452 may comprise group beam-switches for switching the phases of the antenna groups 402.

Those skilled in the art will appreciate that, while the blade boards 454 in the embodiments shown in FIGS. 15A to 17 are in a rectangular shape, the blades antenna structure allows conformal or arbitrary shape array which may be advantages in some steering situations.

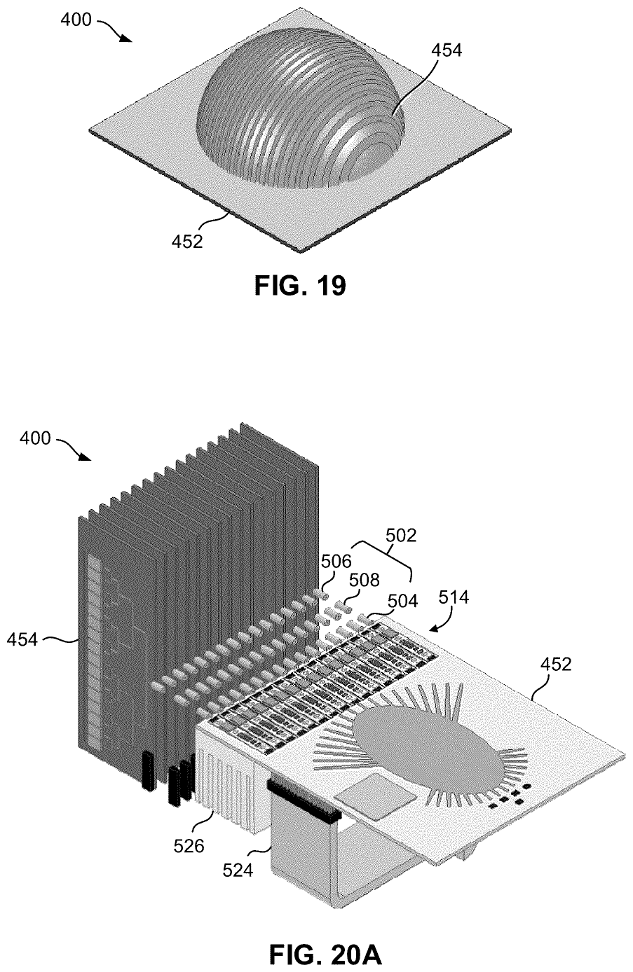

For example, in some embodiments as shown in FIG. 18, the blade boards 454 may be in a semi-circular shape of the same size, and thus the ensemble of the blade boards 454 of the two-level phased-array 400 is in a semi-cylindrical shape. In some other embodiments as shown in FIG. 19, the blade boards 454 may be in a semi-circular shape of different sizes, and the ensemble of the blade boards 454 of the two-level phased-array 400 is in a semi-spherical shape.

Although the blade boards 454 in the embodiments shown in FIGS. 15A, 15B, 18, and 19 are normal to the motherboard 452, in some embodiments, the blade boards 454 may be in parallel to the motherboard 452 (for example, the blade boards 454 coupling to the motherboard 452 via an extension board normal thereto).

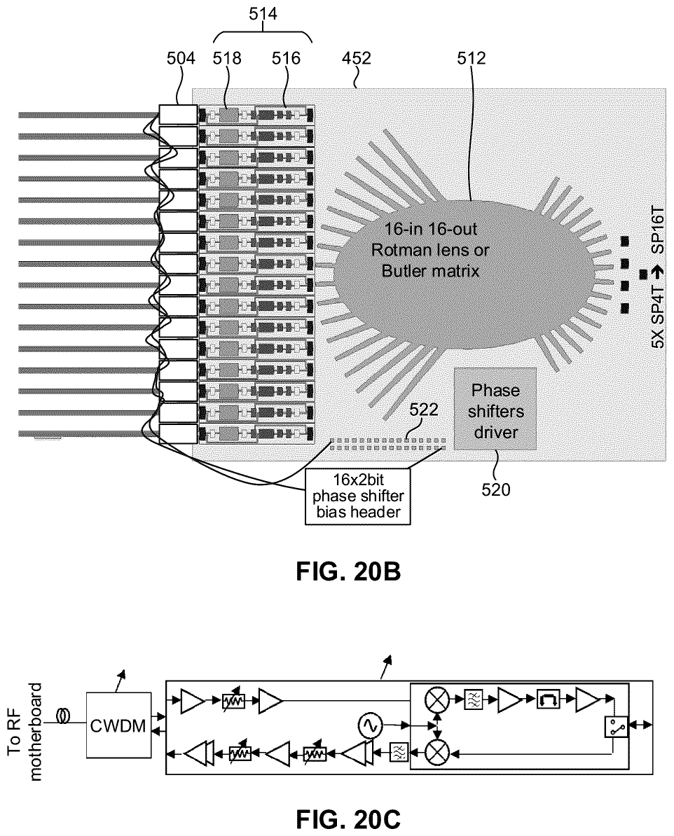

FIG. 20A is a schematic exploded perspective view of a single-polarization, two-level phased-array 400 for further simplifying the motherboard 452 and its integration with the blades 454, according to some embodiments of this disclosure.

Similar to above examples and as shown in FIG. 20B, the motherboard 452 functions for beam-steering along a first plane (using phase shifters or beam switches, as described above). The blade boards function for beam-steering along a second plane (using phase shifters or beam switches, as described above) and are coupled to or otherwise integrated with the motherboard 452 via a plurality of end-launch connector assemblies 502.

As shown in FIG. 20A, each end-launch connector assembly 502 comprises a first end-launch connector 504 coupled to the motherboard 452 and a second end-launch connector 506 coupled to a blade board 454. When the blade board 454 is coupled to the motherboard 452, the first and second end-launch connectors 504 and 506 are coupled and secured together via a transition block or bullet 508 to secure the blade board 454 to the end of the motherboard 452. The motherboard 452 is perpendicular to the blade boards 454.

FIG. 20B shows the detail of the motherboard 452 which comprises a 16-in 16-out Rotman lens or Butler matrix 512, a plurality of TRXs 514 each having a transmitter 516 and a receiver 518, a phase-shifters driver 520, a 16×2-bit phase-shifter bias header 522 connecting to the first end-launch connector 504 via a cable 524 (see FIG. 20A) for control and DC, and a heatsink 526 coupled to the rear side of the motherboard 452 about the TRXs 514 (see FIG. 20A).

FIG. 20C shows an exemplary control circuit connecting to the motherboard 452 for controlling the motherboard 452 and the blade boards 454 for beam steering.

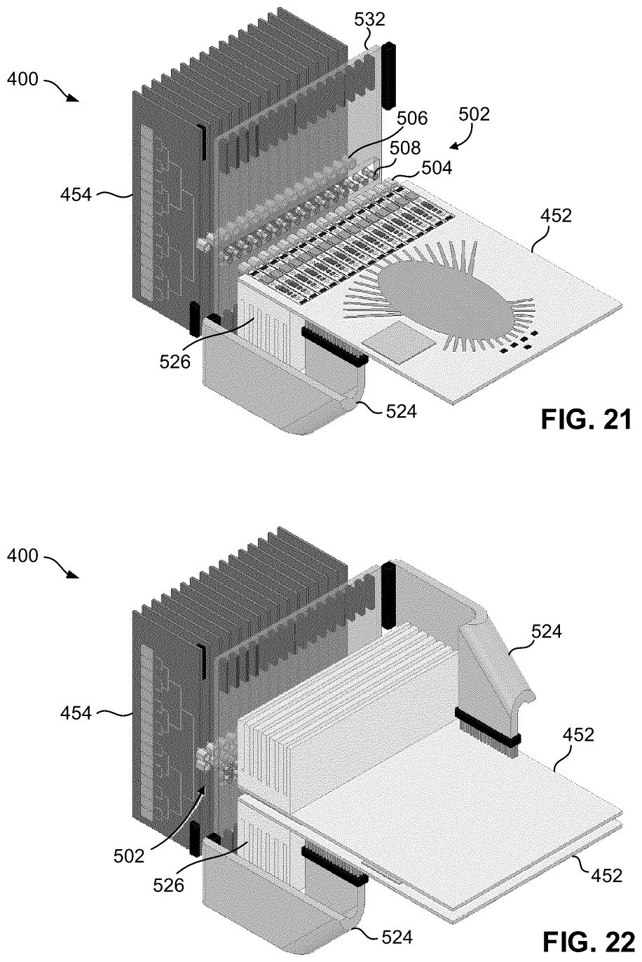

FIG. 21 is a schematic exploded perspective view of a single-polarization, two-level phased-array 400 according to some embodiments of this disclosure. The two-level phased-array 400 in these embodiments is similar to that shown in FIG. 20A except that the two-level phased-array 400 in these embodiments comprises an extension board 532 having the transition blocks 508 mounted thereon for case of securing the blade boards 454 and for case of wiring between the motherboard 452 and the blade boards 454.

With the blades antenna structure, phased array with dual polarization may be easily implemented. For example, FIG. 22 is a schematic exploded perspective view of a dual-polarization, two-level phased-array 400 according to some embodiments of this disclosure. The dual-polarization, two-level phased-array 400 comprises two motherboards 452 arranged in parallel, each being similar to the motherboards 452 showing in FIGS. 20A and 20B and for forming and steering a signal beam of a specific polarization. Two sets of end-launch connector assemblies 502 are used for coupling the blade boards 454 to the two motherboards 452. Each blade board 454 may support two polarizations wherein the extra polarization phase-shifters and feeding network may be implemented on the other side of the blade board 454 (that is, the side opposite to the antenna elements 304). In these embodiments, the motherboards 452 are perpendicular to the blade boards 454.

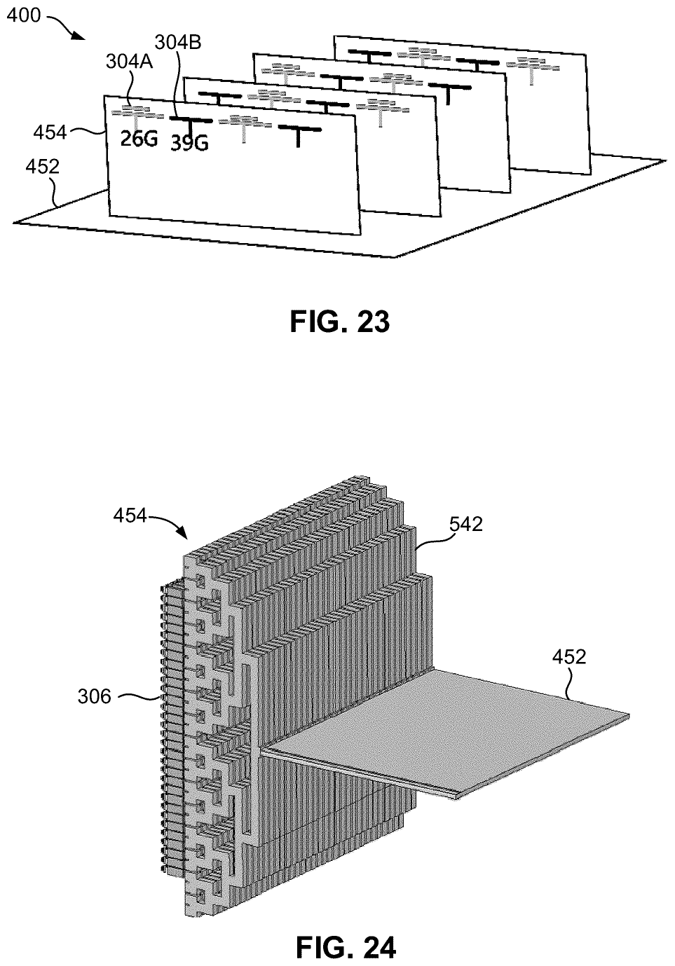

The extra space obtained by the blades antenna structure may also be used to for implementing dual-band phased-array. FIG. 23 shows an example of a dual-band interleaved (26 gigahertz (GHz) and 39 GHZ) two-level phased-array 400. The two-level phased-array 400 in this example is similar to that shown in FIG. 15A except that, in this example, each blade board 454 comprises a first set of antenna elements 304A for forming a first signal beam of 26 GHZ, interleaved with a second set of antenna elements 304B for forming a second signal beam of 39 GHz. The blade boards 454 in this example may use TRX multi-chip modules (MCMs). Table 3 below shows the estimate of TRX MCM in this example.

TABLE 3
ESTIMATE OF TRX MCM

| | Package width | Package height | Antenna | |
|---|---|---|---|---|
| Band | (millimeter (mm)) | (mm) | width (mm) | Antenna ratio |
| 26 | 7 | 7 | 93 | 10% |
| 39 | 6 | 7 | 62 | 20% |
| 68 | 7 | 10 | 71 | 50% |
| 73 | 7 | 10 | 66 | 58% |

With the blades antenna structure, the two-level phased-array 400 obtains extra space for arranging the components on the motherboard 452 and for coupling the blade boards 454, thereby achieving various advantages such as:
simplified routing and thus simplified PCB technology for the motherboard 452;
easy integration or coupling between the blade boards 454 and the motherboard 452;
easy access to heatsink with improved thermal solution; and
more space for facilitating dual polarization or dual band if required.

In above embodiments and examples, the motherboard 452 comprises the LNA. Therefore, the loss of the blade board 454 may be very critical to the system noise figure. At high frequency, the MSL loss of the end-fire antenna elements 304 of the blade boards 454 may be high. Thus, it may be preferable to use waveguide or SIW for implementing the end-fire antenna elements 304 of the blade boards 454 for high-frequency signal beams.

For example, FIG. 24 is a schematic perspective view of a two-level phased-array 400 for forming and steering a signal beam of 72 GHz, according to some embodiments of this disclosure. In these embodiments, the end-fire antenna elements 304 of the blade boards 454 are implemented using waveguides 542 (instead of MSLs) arranged in parallel and perpendicular to the motherboards 452. Accordingly, a waveguide to MSL transition is needed which may be implemented by transitioning from MSL to SIW then transitioning from SIW to waveguide. The two-level phased-array 400 achieves lower RF loss for the blade board feeding network compared to the above-described MSL-based two-level phased-array implementations.

In some embodiments, instead of using the group phase-shifters 406, group waveguides or group SIWs may be used for changing the phases of the antenna groups 402. In some embodiments, the group waveguides or group SIWs may be implemented on the motherboard.

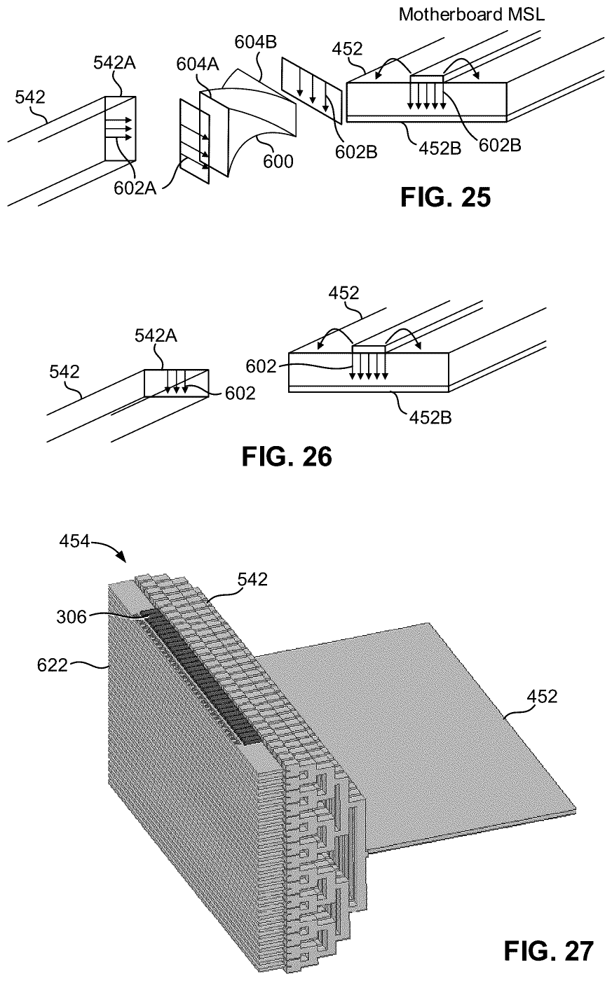

In the embodiments shown in FIG. 25, the orientation of the interface 542A (along the wide edge thereof) of waveguide 542 of the blade boards 454 is different to that of the interface 452B of the motherboard 452, and thus the electrical field direction 602A of the waveguide 542 is misaligned with the electrical field direction 602B of the motherboard 452. Therefore, the transition from the motherboard 452 to the waveguides 542 of the blade boards 454 requires a twist structure 600 therebetween for transitioning the electrical field direction 602A of the waveguide 542 to the electrical field direction 602B of the motherboard 452. The twist structure 600 has a first interface 604A for coupling to the interface 542A of the waveguide 542 and a second interface 604B for coupling to the interface 452B of the motherboard 452. The first interface 604A of the twist structure 600 has the same orientation as that of the interface 542A of the waveguide 542 for aligning with the electrical field direction 602A, and the second interface 604B has the same orientation as that of the interface 452B of the motherboard 452 for aligning with the electrical field direction 602B. However, such as twist structure 600 may be difficult to manufacture.

In some embodiments as shown in FIG. 26, the need for twist structure 600 may be eliminated by changing the dimensions of the blade waveguides 542 such that the orientation of the interface 542A is aligned with that of the interface 452B of the motherboard 452.

In some embodiments as shown in FIG. 27, the waveguides 542 are coupled to a plurality of stacked coupling circuit boards 622 each having one or more element phase-shifters 306 thereon, which provides various advantages such as:
eliminating the need of the waveguide twist transition 600;
each coupling circuit board 622 having a simplified routing/stack-up as all element phase-shifters 306 on the same blade board 454 use the same settings (in some embodiments, all element phase-shifters 306 on the same blade board 454 may be the same phase shifter; moreover, in some other embodiments, multiple antenna elements 304 may be controlled by the same element phase-shifters 306, which may further simplify the phase-shifter implementation); and
easy implementation of the group phase-shifters 406 (not shown) for beam-steering plane (such as the elevation plane) of the motherboard 452 since the blade boards 454 are on the same axis of elevation steering.

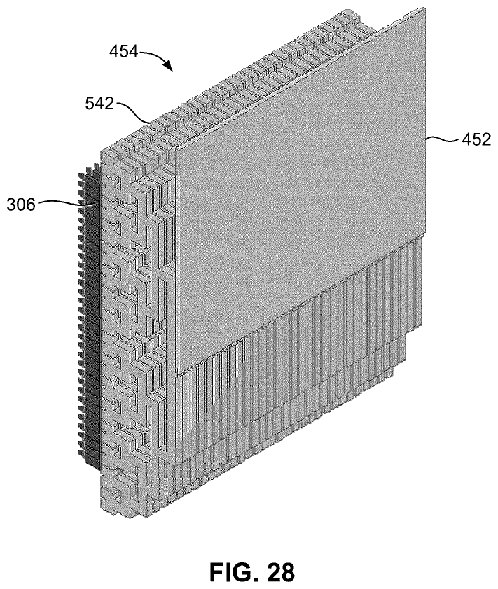

FIG. 28 shows a two-level phased-array 400 according to some embodiments of this disclosure. The two-level phased-array 400 in these embodiments is similar to that shown in FIG. 25 except that, in these embodiments, the motherboard 452 is parallel to the waveguides 542 thereby not requiring a waveguide twist transition (see FIG. 26) and allowing simple waveguide transition which may be implemented by a simple patch excitation.

Although in above embodiments and examples, the two-level phased-array 400 are described as part of a communication system 100, those skilled in the art will appreciate that the two-level phased-array 400 disclosed herein may also be used in other systems such as sensing systems, imaging systems, and/or the like for 3D beam steering.

In above embodiments and examples, the two-level phased-array 400 are described for forming and steering a transmitter beam. In some embodiments, a receiver may also use the two-level phased-array 400 to provide receiver-side directivity by focusing the reception towards one or more directions of target signals while suppressing interference arriving from other directions, thereby effectively forming a beam on the receiver side (denoted a “receiver beam”). In some embodiments, time division duplexing (TDD) may be used for switching the two-level phased-array 400 between the TX and the RX mode.

### D. Acronym Key

BGA: Ball Grid Array
IF: Intermediate Frequency
LNA: Low Noise Amplifier
MSL: Microstrip-Line
PA: Power Amplifier
PCB: Printed Circuit Board
PS: Phase Shifter
RF: Radio Frequency
SIW: Substrate Integrated Waveguide
SPDT: Single Pole Double Through Switch
TRX: Transceiver

### E. References:

[1] N.-C. Liu, C.-C. Tien, C.-Y. Chang, H.-W. Ling, C.-W. Chiu and J.-H. Tarng, “Millimeter-Wave 2-D Beam-Switchable and Scalable Phased Antenna Array,” in IEEE Transactions on Antennas and Propagation, vol. 69, no. 12, pp. 8997-9002 December 2021, doi: 10.1109/TAP.2021.3098583

Although embodiments have been described above with reference to the accompanying drawings, those of skill in the art will appreciate that variations and modifications may be made without departing from the scope thereof as defined by the appended claims.

1. A method comprising:
controlling one or more antenna elements in each of one or more antenna groups for steering a signal beam along a first plane; and
controlling the one or more antenna groups for steering the signal beam along a second plane.

2. The method of claim 1, wherein the first plane is an elevation plane and the second plane is an azimuth plane.

3. The method of claim 1, wherein the first plane is perpendicular to the second plane.

4. The method of claim 1, wherein the first plane is one of an elevation plane and an azimuth plane, and the second plane is the other one of the elevation plane and the azimuth plane.

5. The method of claim 1, wherein said controlling the one or more antenna elements in each of the one or more antenna groups for steering the signal beam along the first plane comprises:
controlling the one or more antenna elements in each of the one or more antenna groups using one or more first phase shifters, one or more first beam switches, or one or more first waveguides for steering the signal beam along the first plane; and/or
wherein said controlling the one or more antenna groups for steering the signal beam along the second plane comprises:
controlling the one or more antenna groups using one or more second phase shifters, one or more second beam switches, or one or more second waveguides for steering the signal beam along the second plane.

6. An antenna array comprising:
a plurality of antenna elements partitioned into one or more antenna groups, each antenna group comprising one or more antenna elements;
a plurality of first beam-steering components each connected to one of the plurality of antenna elements for steering a signal beam along a first plane; and
one or more second beam-steering components each connected to one of the one or more antenna groups for steering the signal beam along a second plane.

7. The antenna array of claim 6, wherein the first plane is one of an elevation plane and an azimuth plane, and the second plane is the other one of the elevation plane and the azimuth plane.

8. The antenna array of claim 6, wherein the one or more first beam-steering components comprise one or more first phase shifters, one or more first beam switches, or one or more first waveguides; and/or
wherein the one or more second beam-steering components comprise one or more second phase shifters, one or more second beam switches, or one or more second waveguides.

9. The antenna array of claim 6 further comprising:
one or more first circuit structures comprising the plurality of antenna elements and the one or more first beam-steering components; and
at least one second circuit structure coupled to the one or more first circuit structures and comprising the one or more second beam-steering components.

10. The antenna array of claim 9, wherein the at least one second circuit structure comprises at least one second circuit board.

11. The antenna array of claim 10, wherein the at least one second circuit board comprises a plurality of components attached thereto using wire-bonds, flip-chipped, and/or wire-bond ball-grid arrays (BGA) packages.

12. The antenna array of claim 10, wherein the at least one second circuit board comprises a plurality of transmitters and/or receivers.

13. The antenna array of claim 12, wherein the at least one second circuit board comprises a heatsink; and wherein the heatsink and the plurality of transmitters and/or receivers are on opposite sides of the at least one second circuit board.

14. The antenna array of claim 9, wherein the one or more first circuit structures comprise a plurality of first circuit structures spaced apart from each other and are parallel to each other.

15. The antenna array of claim 14, wherein each adjacent pair of the plurality of first circuit structures have a distance of λ/2 therebetween, where λ is the wavelength of the signal beam.

16. The antenna array of claim 14, wherein the plurality of first circuit structures are spaced apart by one or more spacers.

17. The antenna array of claim 14, wherein the plurality of first circuit structures are coupled to one side of the at least one second circuit structure in an orientation perpendicular to the at least one second circuit structure.

18. The antenna array of claim 17, wherein the plurality of first circuit structures are coupled to the one side of the at least one second circuit structure via RF connectors, substrate-integrated waveguides (SIWs), and/or soldering.

19. The antenna array of claim 9, wherein the at least one second circuit structure comprises two second circuit boards parallel to each other.

20. The antenna array of claim 19, wherein the two second circuit boards are configured for steering signal beams of different polarizations.
